(19) United States
(12) Patent Application Publication
(10) Pub. No.: US 2025/0284938 A1
(43) Pub. Date: Sep. 11, 2025

(54) MODULATED SOFTMAX ATTENTION FOR IMPROVING ATTENTION MECHANISMS IN DEEP NEURAL NETWORKS

(71) Applicants: DISNEY ENTERPRISES, INC., Burbank, CA (US); ETH Zürich (Eidgenössische Technische Hochschule Zürich), Zürich (CH)

(72) Inventors: Tunc Ozan AYDIN, Zürich (CH); Farnood SALEHI, Zürich (CH); Arad MOHAMMADI, Dübendorf (CH)

(21) Appl. No.: 19/072,710

(22) Filed: Mar. 6, 2025

Related U.S. Application Data
(60) Provisional application No. 63/562,372, filed on Mar. 7, 2024.

(51) Int. Cl. G06N 3/048; G06N 3/0455

(52) U.S. Cl. CPC G06N 3/048; G06N 3/0455

(57) ABSTRACT

The present invention sets forth techniques for generating attention values via a modulated softmax attention mechanism. The techniques include calculating key, query, and value matrices associated with an input matrix including one or more input tokens, calculating a first vector including one or more per-token scaling values and a second vector including one or more per-token bias values. The techniques also include generating an attention prior matrix based at least on the first and second vectors, and calculating, for each of the one or more input tokens, a modulated attention score associated with the input token. The techniques further include calculating a matrix including one or more modulated attention values associated with the one or more input tokens, and transmitting the one or more modulated attention values to at least one stage included in a transformer network.

### CROSS-REFERENCE TO RELATED APPLICATIONS

This application claims priority benefit to U.S. Provisional application titled “MODULATED SOFTMAX ATTENTION FOR IMPROVING ATTENTION MECHANISMS IN DEEP NEURAL NETWORKS,” filed on Mar. 7, 2024, and having Ser. No. 63/562,372. This related application is also hereby incorporated by reference in its entirety.

### BACKGROUND

### Field of the Various Embodiments

Embodiments of the present disclosure relate generally to deep neural networks and, more specifically, to techniques for improving attention mechanisms in deep neural networks, including all aspects of the related hardware, software, graphical user interfaces, and algorithms associated with implementing the contemplated systems, techniques, functions, and operations set forth herein,

### Description of the Related Art

In the field of machine learning, attention mechanisms include techniques used in deep learning models that allow the model to selectively focus on specific areas of the input data when performing inference operations. An attention mechanism is a function that maps a query and a set of key-value pairs to an output, where the query, keys, values, and output are all vectors. The output is computed as a weighted sum of the values, where the weight assigned to each value is computed by a compatibility function of the query with the corresponding key. The key-value attention mechanism separates the source-side content vector into two types of memory known as the key and the value. The key is used for calculating the attention distribution, and the value is used for encoding the context representation. Attention mechanisms are often incorporated into transformer networks, which are widely implemented in language modeling tasks. Transformer networks also achieve state-of-the-art performance in vision tasks, such as image classification and image restoration tasks, including super-resolution and denoising.

Existing attention mechanism techniques may include learning weight matrices Wₖ, W_{q}, and Wᵥ associated with the keys, queries, and values, respectively. These matrices are learning during model training, and fixed thereafter. When the trained model encounters novel inputs during subsequent inference operations, the attention mechanism is not operable to adapt values included in its weight matrices to the novel inputs, potentially leading to reduced accuracy in inference results.

Attention mechanisms may incur computational costs that scale quadratically with the total number of model parameters. Existing adaptations to attention mechanism techniques may attempt to reduce computational costs without significantly decreasing model accuracy. For example, existing techniques may employ kernel approximations in place of computationally expensive exponential dot product operations, or may group input tokens into buckets for local attention based on a defined proximity or other similarity among the input tokens. While these adaptations may reduce computational costs, the adaptations may also come at the cost of decreased model accuracy.

As the foregoing illustrates, what is needed in the art are more effective techniques for implementing attention mechanisms in transformer networks.

### SUMMARY

One embodiment of the present invention sets forth a technique for generating attention values via a modulated softmax attention mechanism. The technique includes calculating key, query, and value matrices associated with an input matrix including one or more input tokens, calculating a first vector including one or more per-token scaling values and a second vector including one or more per-token bias values. The technique also includes generating an attention prior matrix based at least on the first and second vectors, and calculating, for each of the one or more input tokens, a modulated attention score associated with the input token. The technique further includes calculating a matrix including one or more modulated attention values associated with the one or more input tokens, and transmitting the one or more modulated attention values to at least one stage included in a transformer network.

One technical advantage of the disclosed techniques relative to the prior art is that the disclosed techniques provide a learnable set of modulation values that shift and scale attention weights associated with individual input tokens and/or embedding dimensions. The disclosed techniques increase the accuracy of transformer models at a negligible additional computational cost, as the learnable set of modulation weights typically represent an increase of 0.5% or less in the total number of transformer model parameters. The disclosed techniques may also be easily incorporated into existing attention mechanisms, providing increased model accuracy with minimal adaptation. These technical advantages provide one or more improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments of the present invention.

FIG. 2 is a more detailed illustration of the training engine of FIG. 1, according to some embodiments.

FIG. 3 is a flow diagram of method steps for training an attention mechanism including a set of modulation weights, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

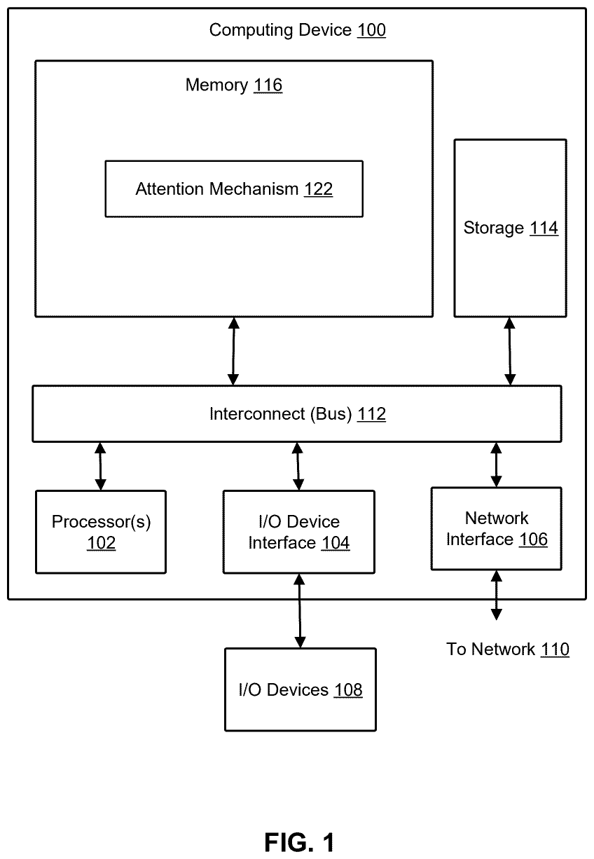

FIG. 1 illustrates a computing device 100 configured to implement one or more aspects of various embodiments of the present invention. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run attention mechanism 122 that resides in a memory 116.

It is noted that the computing device described herein is illustrative and that any other technically feasible configurations fall within the scope of the present disclosure. For example, multiple instances of attention mechanism 122 could execute on a set of nodes in a distributed and/or cloud computing system to implement the functionality of computing device 100. In another example, attention mechanism 122 could execute on various sets of hardware, types of devices, or environments to adapt attention mechanism 122 to different use cases or applications. In a third example, attention mechanism 122 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (Wi-Fi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Attention mechanism 122 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including attention mechanism 122.

### Baseline Self-Attention Mechanism

A baseline self-attention mechanism generates a self-attention output matrix y associated with a given input X∈ [symbol] ^{N×C}, where N represents the number of tokens included in the input, and C is the embedding dimension. As an example, if the input X includes a two-dimensional (2D) RGB image having N pixels, each of N input tokens may represent a single pixel. Each pixel may include three associated color channels (red, green, and blue) resulting in an embedding dimension C=3.

The baseline attention mechanism calculates a key matrix K∈ [symbol] ^{N×D}, a query matrix Q∈ [symbol] ^{N×D}, and a value matrix V∈ [symbol] ^{N×D}, where D represents a constant latent vector size associated with key, query, and value vectors. The baseline attention mechanism calculates the K, Q, and V matrices by applying a linear projection to input X:

$$K = {XW}_{K}^{T} , Q = {XW}_{Q}^{T} , V = {XW}_{V}^{T} , \qquad Equation ( 1 )$$

where the projection matrices W_{Q}, W_{K} and W_{V}∈ [symbol] ^{D×C} are learnable. The attention score A and the self-attention output matrix y are then calculated as

$$A = softmax ( \frac{{QK}^{T}}{\sqrt{D}} ) ∈ {ℝ}^{N \times N} , \qquad Equation ( 2 )$$

$$y = A \cdot V , \qquad Equation ( 3 )$$

where the softmax function is evaluated in a row-wise manner.

The attention score A is calculated in a fully relational, pairwise manner, such that the attention y paid by the transformer model to a particular input token i depends on pairwise relationships between the input token i and other tokens included in the input. The baseline self-attention mechanism does not incorporate an overall or global importance value associated with a particular input token, where the overall or global importance value is independent of relationships between pairs of input tokens. Further, the projection matrices W_{Q}, W_{K} and W_{V} are learned while training the transformer model that includes the baseline self-attention mechanism, and remain fixed thereafter during subsequent testing, validation, and/or inference operations. The fixed nature of the projection matrices may reduce the accuracy of the transformer model when the model processes novel inputs.

### Modulated Softmax Attention Mechanism

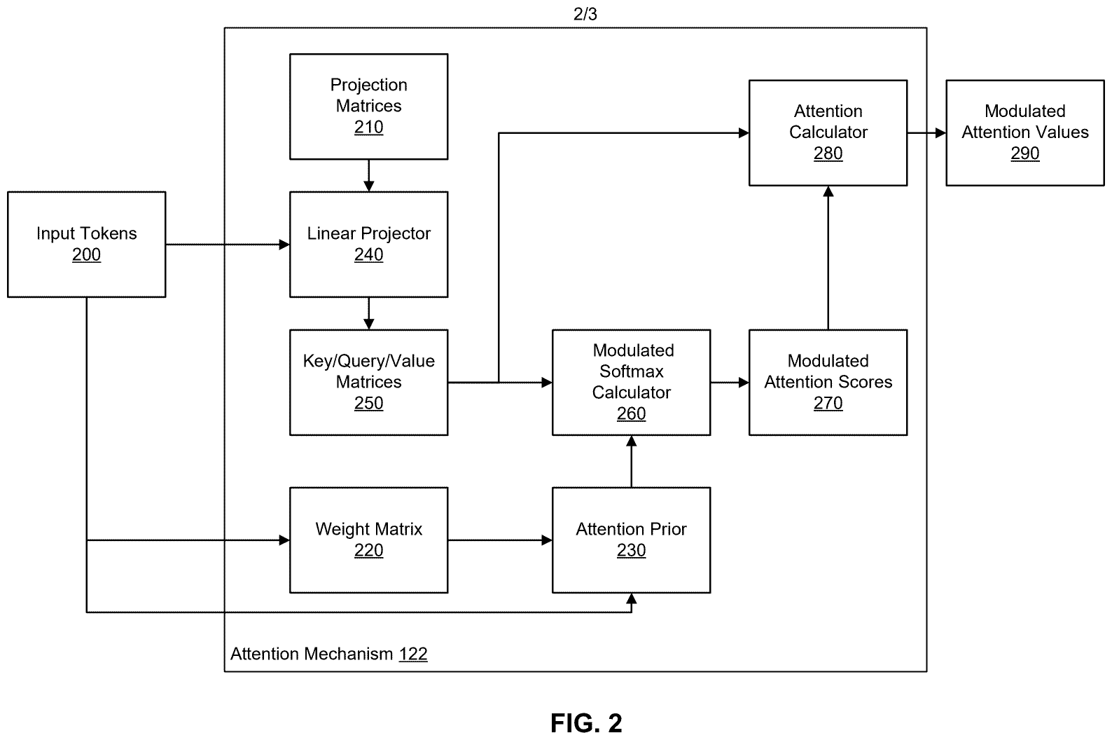

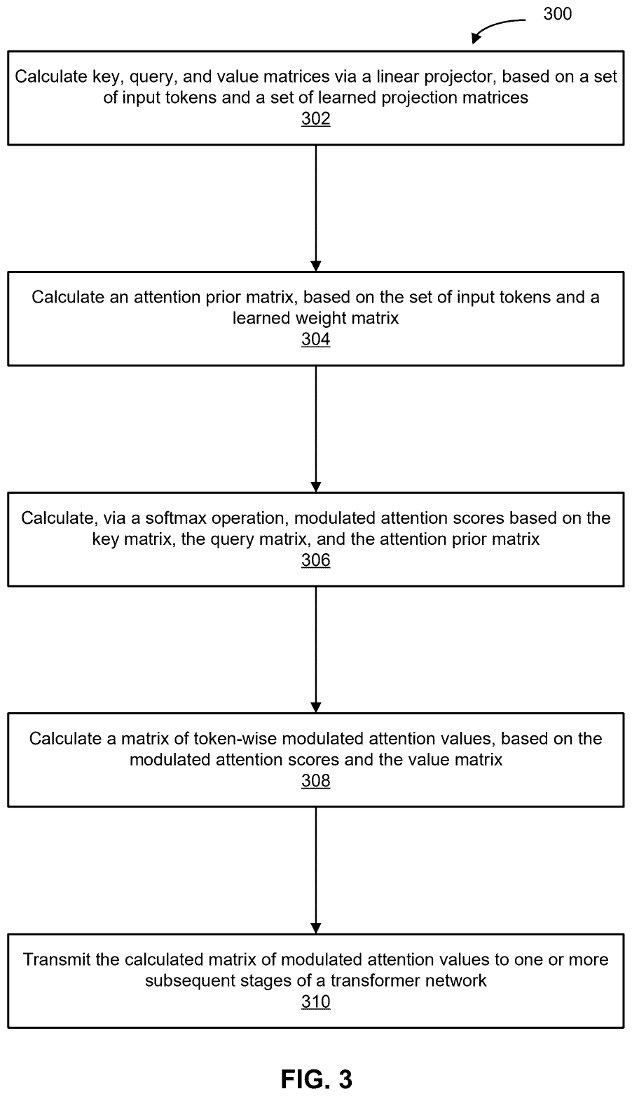

A modulated softmax attention mechanism, discussed below in the detailed descriptions of FIGS. 2 and 3, modifies the baseline self-attention mechanism described above via the introduction of a learnable weight matrix W_{M}∈ [symbol] ^{2×C}. The modulated softmax attention mechanism performs a linear projection on the learnable weight matrix and the input X to calculate token-wise scaling and bias vectors s and b, respectively. The token-wise scaling and bias vectors represent global, token-wise measures of importance that are independent of pairwise relationships between individual tokens. A modulated softmax operation generates modulated attention scores associated with each token included in input X, based on query and key vectors associated with input X and the scaling and bias vectors s and b. The modulated softmax attention mechanism calculates modulated attention values for each input token based on the modulated attention scores and a value vector associated with input X. The modulated softmax attention mechanism incorporates token-wise importance, improving the subsequent performance of a transformer network that includes the modulated softmax attention mechanism. The learnable weight matrix W_{M} includes (2×C) additional parameters compared to the baseline self-attention mechanism, which results in a small (e.g., 0.5% or less) increase in the total number of parameters compared to a transformer network that includes a baseline self-attention mechanism.

FIG. 2 is a more detailed illustration of attention mechanism 122 of FIG. 1, according to some embodiments. Attention mechanism 122 analyzes input tokens 200 and generates token-wise modulated attention values 290. Attention mechanism 122 includes, without limitation, projection matrices 210, weight matrix 220, attention prior 230, linear projector 240, key/query/value matrices 250, modulated softmax calculator 260, modulated attention scores 270, and attention calculator 280.

In various embodiments, input tokens 200 includes an input matrix X∈ [symbol] ^{N×C}, where N represents the number of tokens and C is the embedding dimension. For example, input tokens 200 may include a two-dimensional (2D) RGB image having a rectangular array of multiple pixels, where each pixel includes red, green, and blue color channel values. In this example, N would represent the total number of pixels, while C would represent the number of color channels (three, in this example). In other embodiments, each token may represent a collection of contiguous pixels, and the color channel values associated with the token may be based on a combination of color channel values associated with individual pixels included in the collection of contiguous pixels. Attention mechanism 122 transmits input tokens 200 to linear projector 240 and attention prior 230 described below.

Projection matrices 210 may include three projection matrices—W_{Q}, W_{K} and W_{V}∈ [symbol] ^{D×C}, where D represents a constant latent vector length. These projection matrices—or more specifically, their transposes, respectively generate query, key, and value matrices when multiplied by input matrix X included in input tokens 200, as discussed below in the description of linear projector 240. In various embodiments, projection matrices W_{Q}, W_{K} and W_{V} may be learned while training a transformer network that includes attention mechanism 122, and remain fixed after training is complete. Attention mechanism 122 transmits projection matrices 210 to linear projector 240.

Linear projector 240 calculates key matrix K, query matrix Q, and value matrix V, based on input tokens 200 and the transposes of projection matrices 210. Linear projector 240 utilizes the same linear projection technique as described above in the discussion of the baseline self-attention mechanism:

$$K = {XW}_{K}^{T} , Q = {XW}_{Q}^{T} , V = {XW}_{V}^{T} \qquad Equation ( 1 )$$

Attention mechanism 122 stores the calculated K, Q, and V matrices as key/query/value matrices 250. Attention mechanism transmits the V matrix to attention calculator 280, and transmits the K and Q matrices to modulated softmax calculator 260.

Weight matrix 220 may include a weight matrix W_{M}∈ [symbol] ^{2×C}. Similar to projection matrices W_{Q}, W_{K} and W_{V}, weight matrix W_{M} may be learned while training a transformer network that includes attention mechanism 122. Attention mechanism 122 calculates a per-token scale vector s∈ [symbol] ^{1×N} and a per-token bias vector b∈ [symbol] ^{1×N} via a dot product multiplication between the input X and the transpose W_{M}^{T} of the weight matrix W_{M}:

$$[ s , b ] = X \cdot {W}_{M}^{T} \qquad Equation ( 4 )$$

Scale vector s includes real-valued multiplicative scaling factors associated with each of the N tokens included in input tokens 200, while bias vector b includes real-valued additive bias factors associated with each of the N tokens included in input tokens 200. Collectively, scale vector s and bias vector b capture a global importance associated with each of the N tokens included in input tokens 200, where the global importance associated with is independent of pairwise relationships between input tokens. Attention mechanism 122 stores scale vector s and bias vector b as attention prior 230.

Attention prior 230 includes per-token scaling and bias values associated with each input token included in input tokens 200. The scaling and bias values enable attention mechanism 122 to adjust, or modulate, the attention paid to individual input tokens by a transformer model. Attention mechanism 122 transmits attention prior 230 to modulated softmax calculator 260.

Modulated softmax calculator 260 generates an attention score matrix A that includes per-token attention scores associated with each of input tokens 200. Modulated softmax calculator 260 includes a modified version of softmax Equation (2) above. In various embodiments, the modification includes the inclusion of multiplicative scale vector s and additive bias vector b:

$$A = softmax ( s ⊗ Q \cdot {K}^{T} ⊕ b ) , \qquad Equation ( 5 )$$

where ⊗ and Γ denote element-wise multiplication and addition, respectively. Attention mechanism 122 stores attention score matrix A as modulated attention scores 270.

Modulated attention scores 270 includes a matrix representation of attention scores associated with input tokens, where the attention score associated with a token has been adjusted based on multiplying the Q vector by the scale vector s and adding the transpose of the K vector to the bias vector b. Attention mechanism 122 transmits modulated attention scores 270 to attention calculator 280.

Attention calculator 280 receives value vector V and modulated attention scores 270, and calculates a modulated self-attention value matrix y that includes self-attention values associated with each input token included in input tokens 200. Attention calculator 280 operates in the same manner as the baseline self-attention mechanism described above, performing a dot product matrix multiplication between the modulated attention scores A and the value vector V:

$$y = A \cdot V \qquad Equation ( 3 )$$

Attention mechanism 122 stores the self-attention value matrix y as modulated attention values 290, and transmits modulated attention values 290 to one or more subsequent stages of a transformer network that includes attention mechanism 122.

### Cross-Covariance Attention

Another type of attention mechanism, cross-covariance attention, calculates the attention scores along feature channels, rather than along tokens. The linear projection matrices and the key/query/value matrices have the same dimensions as described above in the discussions of baseline self-attention and modulated softmax attention. The cross-covariance attention mechanism may also be modified via the disclosed modulated softmax attention techniques.

Cross-covariance attention calculates the attention score A in a similar manner as described above with reference to baseline self-attention, except that the order of the K^{T} and Q terms are reversed in the dot product multiplication, and the dimensions of A are (D×D) rather than (N×N):

$$A = softmax ( \frac{{K}^{T} \cdot Q}{\sqrt{d}} ) ∈ {ℝ}^{D \times D} \qquad Equation ( 6 )$$

Similarly, cross-covariance incorporating the modulated softmax attention technique calculates the attention output y by performing a dot product multiplication between the attention score A and the value matrix V, except that the order of the terms is reversed:

$$y = V \cdot A \qquad Equation ( 7 )$$

To compute the prior vectors s, b∈ [symbol] ^{1×D} in the modulated cross-covariance technique, the technique employs a weight matrix W_{M}∈ [symbol] ^{2×D}:

$$[ s , b ] = ( {K}^{T} \cdot Q ) \cdot {W}_{M}^{T} \qquad Equation ( 8 )$$

The modified attention score in the modulated cross-covariance technique is given by:

$$A = softmax ( s ⊗ {K}^{T} \cdot Q ⊕ b ) , \qquad Equation ( 9 )$$

where the order of the K^{T} and Q terms is reversed in the dot product multiplication compared to Equation (5) above. In further contrast to Equation (5), the scaling vector s is applied to K^{T}, while the bias vector b is applied to Q.

While the above examples illustrate the application of the disclosed modulated softmax attention technique to a baseline self-attention technique and a cross-covariance attention technique, these examples are not intended to be limiting. The disclosed technique may be applied to a variety of attention techniques included in a variety of transformer networks performing tasks such as natural language processing, image classification, image segmentation, super-resolution, and denoising.

FIG. 3 is a flow diagram of method steps for generating attention values, according to some embodiments. Although the method steps are described in conjunction with the systems of FIGS. 1-2, persons skilled in the art will understand that any system configured to perform the method steps in any order falls within the scope of the present disclosure.

As shown, in step 302 of method 300, linear projector 240 of attention mechanism 122 generates key matrix K, query matrix Q, and value matrix V, based on the set of input tokens X included in input tokens 200 and a set of learned projection matrices W_{Q}, W_{K} and W_{V}. Linear projector 240 multiplies input X by each of the learned projection matrices to generate matrices K, Q, and V:

$$K = {XW}_{K}^{T} , Q = {XW}_{Q}^{T} , V = {XW}_{V}^{T} , \qquad Equation ( 1 )$$

In step 304, attention mechanism 122 generates attention prior 230, based on input X and a learned weight matrix 220 represented by W_{M}. Attention prior 230 includes per-token scaling and bias values that, taken together, represent a global importance associated with an individual input token. Attention mechanism 122 calculates a scaling vector s that includes the per-token scaling values, and a bias vector b that includes the per-token bias values:

$$[ s , b ] = X \cdot {W}_{M}^{T} \qquad Equation ( 4 )$$

In step 306, modulated softmax calculator 260 of attention mechanism 122 calculates a matrix of modulated attention scores 270, based on key matrix K, query matrix Q, and attention prior 230:

$$A = softmax ( s ⊗ Q \cdot {K}^{T} ⊕ b ) , \qquad Equation ( 5 )$$

where ⊗ and Γ denote element-wise multiplication and addition, respectively. Attention mechanism 122 stores attention score matrix A as modulated attention scores 270. Attention mechanism 122 transmits modulated attention scores 270 to attention calculator 280.

In step 308, attention calculator 280 of attention mechanism 122 calculates modulated attention values 290, based on modulated attention scores 270 and value matrix V. Specifically, attention calculator 280 performs a dot product multiplication of modulated attention scores 270, represented by A, and value matrix V:

$$y = A \cdot V , \qquad Equation ( 3 )$$

and stores the resulting attention value matrix y as modulated attention values 290.

In step 310, attention mechanism 122 transmits modulated attention values 290 to one or more subsequent stages of a transformer network that includes attention mechanism 122. The disclosed modulated softmax attention mechanism 122 is operable to calculate modulated attention values in a variety of transformer network applications, including image classification, image segmentation, natural language processing, image super-resolution, and image denoising.

In sum, the disclosed techniques include a transformer network attention mechanism that is operable to calculate per-token importance values associated with each of multiple input tokens presented to a transformer network. The disclosed techniques calculate the per-token importance values based on a learnable weight matrix and generated per-token scaling and bias vectors associated with each input token. The per-token importance values are independent of pairwise relationships between input token, and may be used to refine the attention values calculated by various different conventional attention mechanisms.

In operation, an attention mechanism receives an input X including N tokens, where each token includes one or more channels. For example, each input token may represent a pixel included in an image, and each pixel may include a number of color channels, such as red, green, and blue channels. The attention mechanism also includes multiple learned projection matrices that, when transposed and multiplied by the input X, generate key, query, and value matrices Q, K, and V, respectively.

The attention mechanism also includes a learned weight matrix that, when transposed and multiplied by the input X, generates a vector s of per-token multiplicative scaling values and a vector b of per-token additive bias values. The matrices of per-token scaling and bias values collectively represent an attention prior associated with input X, where the scaling and bias values associated with an individual input token represent a global importance associated with the individual token. In contrast to conventional self-attention mechanisms, the global importance value associated with a token is independent of any pairwise relationships between input tokens, and may be used to modulate the attention scores generated for each input token.

Based on the attention prior and the key, query, and value matrices, the attention mechanism generates a matrix of modulated attention scores, where each modulated attention score is associated with an individual input token. Specifically, the attention mechanism performs an element-wise multiplication of the scaling vector s with the query matrix Q, and also performs an element addition of the bias vector b and the transpose of the key matrix K. The attention mechanism then performs a dot product multiplication on the results of the element-wise operations, followed by a row-wise execution of a softmax function to generate the matrix A of modulated attention scores.

Finally, the attention mechanism calculates an array y of modulated attention values via a dot product multiplication of the modulated attention scores A and the value matrix V. The attention mechanism transmits the modulated attention values y to a transformer network for subsequent operations. The disclosed modulated softmax attention mechanism is operable to calculate attention values in a variety of transformer network applications, including image classification, image segmentation, natural language processing, image super-resolution, and denoising.

One technical advantage of the disclosed techniques relative to the prior art is that the disclosed techniques provide a learnable set of modulation values that shift and scale attention weights associated with individual input tokens and/or embedding dimensions. The disclosed techniques increase the accuracy of transformer models at a negligible additional computational cost, as the learnable set of modulation weights typically represent an increase of 0.5% or less in the total number of transformer model parameters. The disclosed techniques may also be easily incorporated into existing attention mechanisms, providing increased accuracy with minimal adaptation. These technical advantages provide one or more improvements over prior art approaches.
1. In some embodiments, a computer-implemented method for generating modulated attention values, the computer-implemented method comprises calculating key, query, and value matrices associated with an input matrix including one or more input tokens, based on one or more learned linear transformation matrices, calculating a first vector including one or more per-token scaling values and a second vector including one or more per-token bias values, based at least on the input matrix and a learned weight matrix, generating an attention prior matrix based at least on the first and second vectors, calculating, for each of the one or more input tokens, a modulated attention score associated with the input token, based on at least on the attention prior matrix, the key matrix, and the query matrix, calculating a matrix including one or more modulated attention values associated with the one or more input tokens, based at least on the value matrix and the modulated attention scores associated with the input tokens, and transmitting the one or more modulated attention values to at least one stage included in a transformer network.
2. The computer-implemented method of clause 1, wherein calculating the one or more modulated attention values includes performing a row-wise softmax operation.
3. The computer-implemented method of clauses 1 or 2, wherein each of the one or more input tokens includes one or more channels.
4. The computer-implemented method of any of clauses 1-3, wherein each of the one or more input tokens is associated with a pixel included in an image, and each of the one or more channels includes a color channel having an associated color channel value.
5. The computer-implemented method of any of clauses 1-4, wherein generating the attention prior matrix further comprises calculating, for each element included in the attention prior matrix, a multiplicative scaling value based at least on the first vector and an additive bias value based at least on the second vector.
6. The computer-implemented method of any of clauses 1-5, wherein the transformer network performs one or more of an image classification operation, an image segmentation operation, a natural language processing operation, or an image super-resolution operation.
7. The computer-implemented method of any of clauses 1-6, wherein the scaling value and the bias value associated with an input token are independent of pairwise relationships between pairs of input tokens included in the input matrix.
8. In some embodiments, one or more non-transitory computer-readable media store instructions that, when executed by one or more processors, cause the one or more processors to perform the steps of calculating key, query, and value matrices associated with an input matrix including one or more input tokens, based on one or more learned linear transformation matrices, calculating a first vector including one or more per-token scaling values and a second vector including one or more per-token bias values, based at least on the input matrix and a learned weight matrix, generating an attention prior matrix based at least on the first and second vectors, calculating, for each of the one or more input tokens, a modulated attention score associated with the input token, based on at least on the attention prior matrix, the key matrix, and the query matrix, calculating a matrix including one or more modulated attention values associated with the one or more input tokens, based at least on the value matrix and the modulated attention scores associated with the input tokens, and transmitting the one or more modulated attention values to at least one stage included in a transformer network.
9. The one or more non-transitory computer-readable media of clause 8, wherein the steps of calculating the one or more modulated attention values further comprise performing a row-wise softmax operation.
10. The one or more non-transitory computer-readable media of clauses 8 or 9, wherein each of the one or more input tokens includes one or more channels.
11. The one or more non-transitory computer-readable media of any of clauses 8-10, wherein each of the one or more input tokens is associated with a pixel included in an image, and each of the one or more channels includes a color channel having an associated color channel value.
12. The one or more non-transitory computer-readable media of any of clauses 8-11, wherein the steps of generating the attention prior matrix further comprise calculating, for each element included in the attention prior matrix, a multiplicative scaling value based at least on the first vector and an additive bias value based at least on the second vector.
13. The one or more non-transitory computer-readable media of any of clauses 8-12, wherein the transformer network performs one or more of an image classification operation, an image segmentation operation, a natural language processing operation, or an image super-resolution operation.
14. The one or more non-transitory computer-readable media of any of clauses 8-13, wherein the scaling value and the bias value associated with an input token are independent of pairwise relationships between pairs of input tokens included in the input matrix.
15. In some embodiments, a system comprises one or more memories storing instructions, and one or more processors for executing the instructions to calculate key, query, and value matrices associated with an input matrix including one or more input tokens, based on one or more learned linear transformation matrices, calculate a first vector including one or more per-token scaling values and a second vector including one or more per-token bias values, based at least on the input matrix and a learned weight matrix, generate an attention prior matrix based at least on the first and second vectors, calculate, for each of the one or more input tokens, a modulated attention score associated with the input token, based on at least on the attention prior matrix, the key matrix, and the query matrix, calculate a matrix including one or more modulated attention values associated with the one or more input tokens, based at least on the value matrix and the modulated attention scores associated with the input tokens, and transmit the one or more modulated attention values to at least one stage included in a transformer network.
16. The system of clause 15, wherein calculating the one or more modulated attention values includes performing a row-wise softmax operation.
17. The system of clauses 15 or 16, wherein each of the one or more input tokens includes one or more channels.
18. The system of any of clauses 15-17, wherein each of the one or more input tokens is associated with a pixel included in an image, and each of the one or more channels includes a color channel having an associated color channel value.
19. The system of any of clauses 15-18, wherein generating the attention prior matrix further comprises calculating, for each element included in the attention prior matrix, a multiplicative scaling value based at least on the first vector and an additive bias value based at least on the second vector.
20. The system of any of clauses 15-19, wherein the transformer network performs one or more of an image classification operation, an image segmentation operation, a natural language processing operation, or an image super-resolution operation.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating modulated attention values, the computer-implemented method comprising:
calculating key, query, and value matrices associated with an input matrix including one or more input tokens, based on one or more learned linear transformation matrices;
calculating a first vector including one or more per-token scaling values and a second vector including one or more per-token bias values, based at least on the input matrix and a learned weight matrix;
generating an attention prior matrix based at least on the first and second vectors;
calculating, for each of the one or more input tokens, a modulated attention score associated with the input token, based on at least on the attention prior matrix, the key matrix, and the query matrix;
calculating a matrix including one or more modulated attention values associated with the one or more input tokens, based at least on the value matrix and the modulated attention scores associated with the input tokens; and
transmitting the one or more modulated attention values to at least one stage included in a transformer network.

2. The computer-implemented method of claim 1, wherein calculating the one or more modulated attention values includes performing a row-wise softmax operation.

3. The computer-implemented method of claim 1, wherein each of the one or more input tokens includes one or more channels.

4. The computer-implemented method of claim 3, wherein each of the one or more input tokens is associated with a pixel included in an image, and each of the one or more channels includes a color channel having an associated color channel value.

5. The computer-implemented method of claim 1, wherein generating the attention prior matrix further comprises calculating, for each element included in the attention prior matrix, a multiplicative scaling value based at least on the first vector and an additive bias value based at least on the second vector.

6. The computer-implemented method of claim 1, wherein the transformer network performs one or more of an image classification operation, an image segmentation operation, a natural language processing operation, or an image super-resolution operation.

7. The computer-implemented method of claim 1, wherein the scaling value and the bias value associated with an input token are independent of pairwise relationships between pairs of input tokens included in the input matrix.

8. One or more non-transitory computer-readable media storing instructions that, when executed by one or more processors, cause the one or more processors to perform the steps of:
calculating key, query, and value matrices associated with an input matrix including one or more input tokens, based on one or more learned linear transformation matrices;
calculating a first vector including one or more per-token scaling values and a second vector including one or more per-token bias values, based at least on the input matrix and a learned weight matrix;
generating an attention prior matrix based at least on the first and second vectors;
calculating, for each of the one or more input tokens, a modulated attention score associated with the input token, based on at least on the attention prior matrix, the key matrix, and the query matrix;
calculating a matrix including one or more modulated attention values associated with the one or more input tokens, based at least on the value matrix and the modulated attention scores associated with the input tokens; and
transmitting the one or more modulated attention values to at least one stage included in a transformer network.

9. The one or more non-transitory computer-readable media of claim 8, wherein the steps of calculating the one or more modulated attention values further comprise performing a row-wise softmax operation.

10. The one or more non-transitory computer-readable media of claim 8, wherein each of the one or more input tokens includes one or more channels.

11. The one or more non-transitory computer-readable media of claim 10, wherein each of the one or more input tokens is associated with a pixel included in an image, and each of the one or more channels includes a color channel having an associated color channel value.

12. The one or more non-transitory computer-readable media of claim 8, wherein the steps of generating the attention prior matrix further comprise calculating, for each element included in the attention prior matrix, a multiplicative scaling value based at least on the first vector and an additive bias value based at least on the second vector.

13. The one or more non-transitory computer-readable media of claim 8, wherein the transformer network performs one or more of an image classification operation, an image segmentation operation, a natural language processing operation, or an image super-resolution operation.

14. The one or more non-transitory computer-readable media of claim 8, wherein the scaling value and the bias value associated with an input token are independent of pairwise relationships between pairs of input tokens included in the input matrix.

15. A system comprising:
one or more memories storing instructions; and
one or more processors for executing the instructions to:
calculate key, query, and value matrices associated with an input matrix including one or more input tokens, based on one or more learned linear transformation matrices;
calculate a first vector including one or more per-token scaling values and a second vector including one or more per-token bias values, based at least on the input matrix and a learned weight matrix;
generate an attention prior matrix based at least on the first and second vectors;
calculate, for each of the one or more input tokens, a modulated attention score associated with the input token, based on at least on the attention prior matrix, the key matrix, and the query matrix;
calculate a matrix including one or more modulated attention values associated with the one or more input tokens, based at least on the value matrix and the modulated attention scores associated with the input tokens; and
transmit the one or more modulated attention values to at least one stage included in a transformer network.

16. The system of claim 15, wherein calculating the one or more modulated attention values includes performing a row-wise softmax operation.

17. The system of claim 15, wherein each of the one or more input tokens includes one or more channels.

18. The system of claim 17, wherein each of the one or more input tokens is associated with a pixel included in an image, and each of the one or more channels includes a color channel having an associated color channel value.

19. The system of claim 15, wherein generating the attention prior matrix further comprises calculating, for each element included in the attention prior matrix, a multiplicative scaling value based at least on the first vector and an additive bias value based at least on the second vector.

20. The system of claim 15, wherein the transformer network performs one or more of an image classification operation, an image segmentation operation, a natural language processing operation, or an image super-resolution operation.
